(19) United States
(12) Patent Application Publication
(10) Pub. No.: US 2025/0019837 A1
(43) Pub. Date: Jan. 16, 2025

(54) ELECTROLYZED WATER-GENERATING DEVICE

(71) Applicant: D&D ELECTRONICS CO., LTD, Anyang-si, Gyeonggi-do (KR)

(72) Inventors: Jae Won SEO, Anyang-si, Gyeonggi-do (KR); Eun Ju SEO, Anyang-si, Gyeonggi-do (KR)

(73) Assignee: D&D ELECTRONICS CO., LTD, Anyang-si, Gyeonggi-do (KR)

(21) Appl. No.: 18/714,104

(22) PCT Filed: Nov. 25, 2022
(86) PCT No.: PCT/KR2022/018785

§ 371 Date: May 29, 2024

(30) Foreign Application Priority Data
Dec. 1, 2021 (KR) 10-2021-0170084

(51) Int. Cl. C25B 1/04; C25B 15/023; C25B 15/08

(52) U.S. Cl. CPC C25B 1/04; C25B 15/023; C25B 15/08

(57) ABSTRACT

The present invention discloses an electrolyzed water generation device. An electrolyzed water generation device that automatically generates set electrolyzed water is configured according to the present invention. By the electrolyzed water generation device, electrolyzed water having a target concentration ranging from a low concentration to a high concentration can be generated, various types of electrolyzed water that fit different purposes can be generated through compact design, and efficiency of electrolyzed water generation can be improved using low power.

### TECHNICAL FIELD

The present invention relates to a device capable of generating electrolyzed water used for various purposes at home or in business, and more particularly, to an electrolyzed water generation device capable of automatically generating electrolyzed water at a set concentration ranging from a low concentration to a high concentration for the electrolyzed water to be used for various purposes such as sterilization and disinfection of food ingredients and utensils, bleaching of clothing, daily disinfection against viruses and bacteria, sanitary management around living areas, and removal of odors from toilets, sewers, and the like.

### BACKGROUND ART

Generally, in modern society, people live in densely populated areas, group feeding and eating out are common, and migration is facilitated by the development of transportation. Accordingly, bacterial infectious diseases occur frequently and tend to spread in wide areas, and in such conditions, the importance of sanitation cannot be overemphasized.

Nowadays, various types of electrolyzed water generation devices are being developed and used according to the above living conditions.

However, the conventional electrolyzed water generation devices have problems in that they are not able to properly generate electrolyzed water at a set concentration ranging from a low concentration to a high concentration and thus not able to meet a commercial production amount suitable for different purposes.

### DISCLOSURE

### Technical Problem

The present invention is directed to providing an electrolyzed water generation device capable of easily and automatically generating electrolyzed water having a target concentration ranging from a low concentration to a high concentration (from several ppm to several thousands of ppm) through setting a water supply amount, an electrolysis duration, and an electrolyte concentration.

### Technical Solution

One aspect of the present invention provides an electrolyzed water generation device including: a first reservoir in which water supplied through a first supply line and electrolyzed water are stored for circulation; an electrolytic cell connected to the first reservoir and first and second circulation lines and configured to cause salt water circulated through the second circulation line to undergo an electrolytic reaction to generate electrolyzed water and circulate the electrolyzed water to the first reservoir through the first circulation line; a second reservoir connected to the second circulation line through a second supply line having a second pump formed therein and configured to store an electrolyte and add the electrolyte to the water circulated through the second circulation line so that salt water is added to the electrolytic cell; a first pump formed in the first circulation line and operated to circulate the electrolyzed water generated in the electrolytic cell to the first reservoir; and a controller configured to control added amounts of the water and the electrolyte and control on or off of the first pump and the second pump to circulate the electrolyzed water.

Also, the first supply line may be a water supply faucet line and branched into a first branch line and a second branch line, and a first valve and a second valve simultaneously or selectively controlled to be opened or closed by the controller may be formed in the first branch line and the second branch line, respectively.

Also, the first reservoir may have: a plurality of inlets each connected to one of the first branch line and the second branch line; a plurality of circulation ports each connected to one of the first circulation line and the second circulation line; and a plurality of water outlets configured to discharge the electrolyzed water circulated to the first reservoir and stored therein to the outside.

Also, a third valve controlled to be opened or closed by the controller and a check valve configured to prevent a backflow of the electrolyte to the second reservoir may be formed in the second supply line.

Also, a third branch line and a fourth branch line branched from a water discharge line may each be connected to one of the plurality of water outlets, and a fourth valve and a fifth valve simultaneously or selectively controlled to be opened or closed by the controller may be formed in the third branch line and the fourth branch line, respectively.

Also, a pressure sensor configured to check a pressure of the water introduced into the electrolytic cell, check a water pressure acting on the first reservoir and the electrolytic cell to prevent damage to the first reservoir and the electrolytic cell due to the water pressure, and send the checked water pressure to the controller may be formed in the second circulation line.

Also, the controller may control a duration of the electrolytic reaction of the salt water in the electrolytic cell by controlling the added amounts of the water and the electrolyte and the on or off of the first pump and the second pump according to a predetermined amount of time using a timer.

Also, the first reservoir may be a cylindrical tank structure having cut surfaces that face each other and each have one of the inlets and one of the water outlets disposed therein.

Also, the first reservoir may be a cylinder-type or pipe-type tank structure in which the inlets and the water outlets are each disposed in different surfaces.

Also, a moving body configured to move according to a pressure of water selectively added through any one of the plurality of inlets and divide the first reservoir into a first storage area and a second storage area may be formed in the first reservoir.

Also, a magnetic body may be formed at an end of the moving body, and at least one or more magnetic sensors configured to measure a movement position of the moving body through the magnetic body may be formed in the first reservoir.

Also, the moving body may be a blade type separator film structure configured to rotate about a central axis inside the first reservoir which is the cylindrical tank structure.

In addition, the moving body may be a piston type separator film structure configured to linearly move in a first direction or a second direction opposite to the first direction inside the first reservoir which is the cylinder-type or pipe-type tank structure.

### Advantageous Effects

An electrolyzed water generation device that automatically generates set electrolyzed water is configured according to the present invention. By the electrolyzed water generation device, electrolyzed water having a target concentration ranging from a low concentration to a high concentration can be generated, various types of electrolyzed water that fit different purposes can be generated through compact design, and efficiency of electrolyzed water generation can be improved using low power.

Advantageous effects of the present invention are not limited to the above-mentioned advantageous effects, and other unmentioned advantageous effects should be clearly understood by those of ordinary skill in the art from the claims.

### DESCRIPTION OF DRAWINGS

FIG. 1 is a schematic system view of an electrolyzed water generation device to which a reservoir, which is a cylindrical tank structure without a moving body, is applied according to a first embodiment of the present invention.

FIG. 2 is a schematic system view of an electrolyzed water generation device to which a reservoir, which is a cylindrical tank structure with a moving body, is applied according to a second embodiment of the present invention.

FIG. 3 is a schematic system view of an electrolyzed water generation device to which a reservoir, which is a cylinder-type or pipe-type tank structure with a moving body, is applied according to a third embodiment of the present invention.

### BEST MODE OF THE INVENTION

Advantages and features of the present invention and methods of achieving the same should become clear from embodiments described in detail below with reference to the accompanying drawings. However, embodiments according to the technical spirit of the present invention are not limited to the embodiments disclosed below and may be implemented in various different forms. The present embodiments are only provided to make the disclosure of the present invention complete and completely inform those of ordinary skill in the art to which the present invention pertains of the scope of the invention. The scope of the embodiments according to the technical spirit of the present invention is only defined by the scope of the claims.

Terms used in the present specification are for describing the embodiments and are not intended to limit the present invention. In the present specification, a singular expression includes a plural expression unless the context clearly indicates otherwise.

In the present specification, terms such as “include” or “have” are intended to designate the presence of features, numbers, steps, operations, components, parts, or combinations thereof mentioned herein and should not be understood as precluding the possibility of presence or addition of one or more other features, numbers, steps, operations, components, parts, or combinations thereof.

Also, the embodiments described herein will be described with reference to cross-sectional views and/or plan views which are ideal exemplary views of the present invention. Therefore, instead of being limited to specific illustrated forms, the embodiments of the present invention also include necessary changes in shapes. For example, an area illustrated as right-angled may be round or have a shape having a predetermined curvature. Therefore, areas illustrated in the drawings have schematic attributes, and the shapes of the areas illustrated in the drawings are for illustrating specific shapes of areas of a device and are not intended to limit the scope of the invention.

Throughout the specification, the same reference numerals refer to the same components. Therefore, the same reference numerals or similar reference numerals may be described with reference to other drawings even when not mentioned or described in the corresponding drawings. Also, reference numerals may be described with reference to other drawings even when not marked therein.

Hereinafter, embodiments of the present invention will be described with reference to the accompanying drawings.

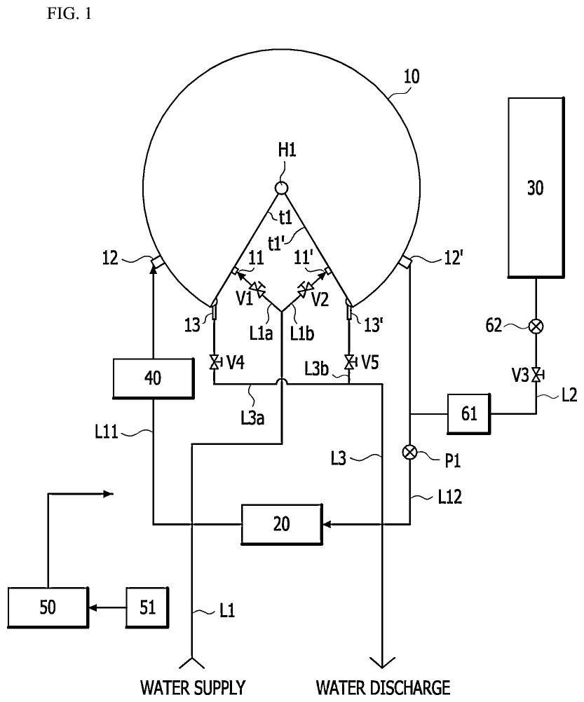

FIG. 1 is a schematic system view of an electrolyzed water generation device to which a reservoir, which is a cylindrical tank structure without a moving body, is applied according to a first embodiment of the present invention.

Referring to FIG. 1, an electrolyzed water generation device according to the first embodiment of the present invention includes a first reservoir 10, an electrolytic cell 20, a second reservoir 30, a first pump 40, a second pump 61, and a controller 50.

The first reservoir 10 receives water through a first supply line L1, which is a water supply faucet line, and then circulates the water or receives electrolyzed water generated by the electrolytic cell 20 and then circulates the electrolyzed water. A plurality of inlets 11 and 11′, a plurality of circulation ports 12 and 12′, and a plurality of water outlets 13 and 13′ are each formed in the first reservoir 10.

The first supply line L1, which is a water supply faucet line, may be branched into a first branch line Lia and a second branch line L1b, the first branch line L1a may be connected to the inlet 11, and the second branch line L1b may be connected to the other inlet 11′. A first valve V1 and a second valve V2 simultaneously or selectively controlled to be opened or closed by the controller 50 may be formed in the first branch line L1a and the second branch line L1b, respectively.

That is, when the first valve V1 is opened, the water supplied from the first supply line L1 may be supplied to the inside of one end of the first reservoir 10 through the first branch line L1a. When the second valve V2 is opened, the water supplied from the first supply line L1 may be supplied to the inside of the other end of the first reservoir 10 through the second branch line L1b.

The first reservoir 10 may be a cylindrical tank structure having cut surfaces t1 and t2 that face each other and each have one of the plurality of inlets 11 and 11′ and one of the plurality of water outlets 13 and 13′ disposed therein.

The first branch line L1a and the second branch line L1b may be connected to each other as the inlets 11 and 11′ are formed in the cut surfaces t1 and t2, respectively.

The circulation ports 12 and 12′ are respectively formed at one end and the other end of the first reservoir 10 which is the cylindrical tank structure, and a first circulation line L11 and a second circulation line L12 each connected to the electrolytic cell 20 may be connected to the plurality of circulation ports 12 and 12′, respectively.

That is, the electrolyzed water generated in the electrolytic cell 20 may be circulated to the first reservoir 10 through the first circulation line L11. Salt water obtained by water discharged from the first reservoir 10 being mixed with an electrolyte is circulated to the electrolytic cell 20 through the second circulation line L12.

Here, when the water is circulated to the electrolytic cell 20 through the second circulation line L12, an electrolyte stored in the second reservoir 30 may be added to the second circulation line L12 through the second supply line L2 and mixed with the water. As a result, the salt water in which the water and the electrolyte are mixed may be added to the electrolytic cell 20. In this case, since it becomes difficult for the electrolyte of the second reservoir 30 to be pumped using the second pump 61 and supplied to the electrolytic cell 20 when the first reservoir 10 is completely filled with the water, the controller 50 performs control to prevent the first reservoir 10 from being completely filled with the water.

The water outlets 13 and 13′ may be formed in the cut surfaces t1 and t2, respectively, and a third branch line L3a and a fourth branch line L3b branched from a water discharge line L3 may be connected to the water outlets 13 and 13′, respectively. When the electrolyzed water generated in the electrolytic cell 20 is repeatedly added to the first reservoir 10 through the first circulation line L11, and the repeatedly added electrolyzed water has a set low concentration or high concentration, the electrolyzed water is discharged to the outside.

A fourth valve V4 and a fifth valve V5 simultaneously or selectively controlled to be opened or closed by the controller 50 may be formed in the third branch line L3a and the fourth branch line L3b, respectively.

That is, when the electrolyzed water having a set concentration is added to and stored in the first reservoir 10, the controller 50 may control the fourth valve V4 and/or the fifth valve V5 to be opened to discharge the electrolyzed water having a set low concentration or high concentration to the outside through the third branch line L3a and/or the fourth branch line L3b.

A pressure sensor P1 may be formed in the second circulation line L12. The pressure sensor P1 may check a pressure of the water introduced into the electrolytic cell 20 and then output the pressure to the controller 50 for the first valve V1 or the second valve V2, which is for supplying the water, to be blocked to prevent problems due to the pressure of the water. Accordingly, the controller 50 may control the supply of the water through the first supply line L1, the on or off of the first pump 40, and the on or off of the second pump 61 formed in the second supply line L2. In this way, the salt water may be easily supplied from the second circulation line L12 into the system, thereby addressing a problem of circulation imbalance that may occur due to the pressure of the water, and when electrolyzed water is generated in the electrolytic cell 20, the generated electrolyzed water may constantly have a set low concentration or high concentration.

Although not illustrated in detail in the drawings, the electrolytic cell 20 typically has an electrode screw terminal connected to a power source and may apply power through the terminal and be connected to the first reservoir 10 through the first circulation line L11 and the second circulation line L12. The electrolytic cell 20 may receive the salt water (water+electrolyte) repeatedly circulated through the second circulation line L12, cause the salt water to undergo an electrolytic reaction to generate electrolyzed water having a set concentration, and repeatedly circulate the electrolyzed water to the first reservoir 10 through the first circulation line L11 for the electrolyzed water to reach a target concentration.

That is, when electrolyzed water that has not reached a set low concentration or high concentration is generated, the electrolytic cell 20 may circulate the electrolyzed water to the first reservoir 10 through the first circulation line L11. Here, a process in which the electrolyzed water and the water are mixed in the first reservoir 10, the mixture is mixed with an electrolyte again through the second circulation line L12, and then the mixture is re-added to the electrolytic cell 20 is repeated, and when electrolyzed water having a set low concentration or high concentration is generated through such repeated circulation, the electrolyzed water is stored in the first reservoir 10.

The second reservoir 30 is connected to the second circulation line L12 through the second supply line L2 and stores an electrolyte therein. For electrolyzed water to be generated when the water is circulated from the first reservoir 10 to the second circulation line L12, the electrolyte may be pumped using the second pump 61 and added to the second circulation line L12 in which the water flows.

That is, when the water is discharged from the first reservoir 10 to the second circulation line L12, the second reservoir 30 adds the electrolyte to the second circulation line L12 through the second supply line L2, and in this way, salt water in which the water and the electrolyte are mixed may be repeatedly supplied to the electrolytic cell 20.

A third valve V3 controlled to be opened or closed by the controller 50, the second pump 61 controlled to be on or off by the controller 50, and a check valve 62 configured to prevent a backflow of the electrolyte to the second reservoir 30 may be formed in the second supply line L2.

That is, when the second pump 61 is on in a state in which the third valve V3 is open according to control of the controller 50, the electrolyte stored in the second reservoir 30 may be pumped and added to the second circulation line L12, in which the water flows, through the second supply line L2. In addition, by the check valve 62, the electrolyte may be prevented from flowing backward to the second reservoir 30.

The first pump 40 is formed in the first circulation line L11 and is controlled to be on by the controller 50 when the electrolyzed water generated in the electrolytic cell 20 is repeatedly circulated to the first reservoir 10 through the first circulation line L11.

That is, when salt water in which the water and the electrolyte are mixed is circulated from the first reservoir 10 to the electrolytic cell 20 through the second circulation line L12 and electrolyzed water is generated, the first pump 40 provides a pumping pressure to repeatedly circulate the electrolyzed water generated in the electrolytic cell 20 to the first reservoir 10 through the first circulation line L11 and may be controlled by the controller 50.

The controller 50 may have an operation program that simultaneously or selectively controls the amount of the water added to the first reservoir 10, the amount of the electrolyte added from the second reservoir 30, the opening or closing of the first to third valves V1, V2, and V3, the on or off of the first and second pumps 40 and 61, and the opening or closing of the fourth and fifth valves V4 and V5 formed in the third and fourth branch lines L3a and L3b, respectively, to allow the salt water or the electrolyzed water to repeatedly circulate.

The controller 50 may sequentially control the opening or closing of the first to fifth valves V1, V2, V3, V4, and V5 while controlling the added amounts of the water and the electrolyte and the on or off of the first and second pumps 40 and 61 according to a predetermined amount of time using a timer 51. Therefore, a duration of the electrolytic reaction of the salt water that occurs in the electrolytic cell 20 may be set to generate electrolyzed water having a desired concentration, that is, a set low concentration or high concentration, in the electrolytic cell 20, and when the electrolyzed water having a set low concentration or high concentration is stored in the first reservoir 10, discharge of the electrolyzed water may be controlled.

That is, in the electrolyzed water generation device according to the first embodiment of the present invention, as in FIG. 1, first, a predetermined amount of water is supplied to the inside of one end or the other end of the first reservoir 10, which is the cylindrical tank structure, through the first branch line L1a and/or the second branch line L1b which are branched from the first supply line L1.

Here, the predetermined amount of water may be a volume of water that fills a storage capacity of the first reservoir 10. The predetermined amount of water may be set by the operation program of the controller 50 and achieved by the controller 50 selectively controlling the first valve V1 or the second valve V2, which is formed in the first branch line Lia or the second branch line L1b branched from the first supply line L1, to be opened.

When the predetermined amount of water is stored inside the one end or the other end of the first reservoir 10, the controller 50 controls the first pump 40 formed in the first circulation line L11 and the second pump 61 formed in the second supply line L2 to be turned on and controls the third valve V3 to be opened.

When the first and second pumps 40 and 61 are turned on, the fourth and fifth valves V4 and V5 respectively formed in the third and fourth branch lines L3a and L3b of the water discharge line L3 may be controlled to be closed by the controller 50.

Meanwhile, since a pumping pressure generated due to the first pump 40 being turned on is transmitted to the first reservoir 10, the water stored in the first reservoir 10 may be circulated to the circulation port 12′ and the second circulation line L12 connected thereto. Here, an electrolyte may be added to the second circulation line L12, and the water may be mixed with the electrolyte. Accordingly, a predetermined amount of salt water may be supplied to the electrolytic cell 20 connected to the second circulation line L12, and by the electrolytic cell 20 causing the salt water supplied thereto to undergo an electrolytic reaction, electrolyzed water having a predetermined concentration may be generated.

The electrolyzed water generated in the electrolytic cell 20 is circulated to the first reservoir 10 according to the pumping pressure generated due to the first pump 40 being turned on, and adding of the salt water to the electrolytic cell 20 through the second circulation line L12 and adding of the electrolyzed water to the first reservoir 10 may be repeated. Such repetition may be performed multiple times for a set amount of time using the timer 51 of the controller 50 until the electrolyzed water has a set low concentration or high concentration.

When the electrolyzed water has a set low concentration or high concentration after undergoing an electrolytic reaction several times through multiple repeated circulations, the controller 50 may control the first valve V1 or the second valve V2 formed in the first branch line L1a or the second branch line L1b of the first supply line L1 to be closed to stop the supply of the water to the first reservoir 10. In this case, the amount of the water obtained by subtracting the amount corresponding to the amount of the electrolyte supplied thereto from the second reservoir 30 is filled in the first reservoir 10. In this way, when the electrolyte is added to the water, the electrolyte may be easily added.

Therefore, a predetermined amount of electrolyzed water having a set low concentration or high concentration may be stored in the first reservoir 10, and the electrolyzed water may be used by being discharged to the outside through the water discharge line L3.

That is, when the electrolyzed water having a set low concentration or high concentration is stored inside the other end or the one end of the first reservoir 10, the controller 50 controls the fourth valve V4 or the fifth valve V5 formed in the third branch line L3a or the fourth branch line L3b branched from the water discharge line L3 to be opened to discharge the electrolyzed water stored in the first reservoir 10 to the outside.

Due to the pressure of the water being pushed into the first reservoir 10, when the first valve V1 formed in the first branch line Lia of the first supply line L1 is opened, the fifth valve V5 formed in the fourth branch line L3b of the water discharge line L3 that is at the opposite side, in other words, in the opposite direction of the direction in which the water enters, is opened. As a result, the electrolyzed water having a low concentration or high concentration that is stored in the first reservoir 10 is completely discharged to the outside due to being discharged by as much as the added amount of the water.

When the water is supplied through the second branch line L1b due to opening of the second valve V2, the electrolyzed water may be discharged through the third branch line L3a in which the fourth valve V4 is open.

The controller 50 may control the fourth valve V4 or the fifth valve V5 to be closed and control the first valve V1 or the second valve V2 formed in the first branch line L1a or the second branch line L1b to be opened. In this case, the water may be re-supplied to the inside of the one end or the other end of the first reservoir 10, and the process of generating electrolyzed water having a set low concentration or high concentration may be performed again by adding an electrolyte to the water to obtain salt water, causing the salt water to undergo an electrolytic reaction to obtain electrolyzed water, and repeatedly circulating the electrolyzed water. The process may be automatically performed by the operation program provided in the controller 50 for a set amount of time using the timer 51.

### Modes of the Invention

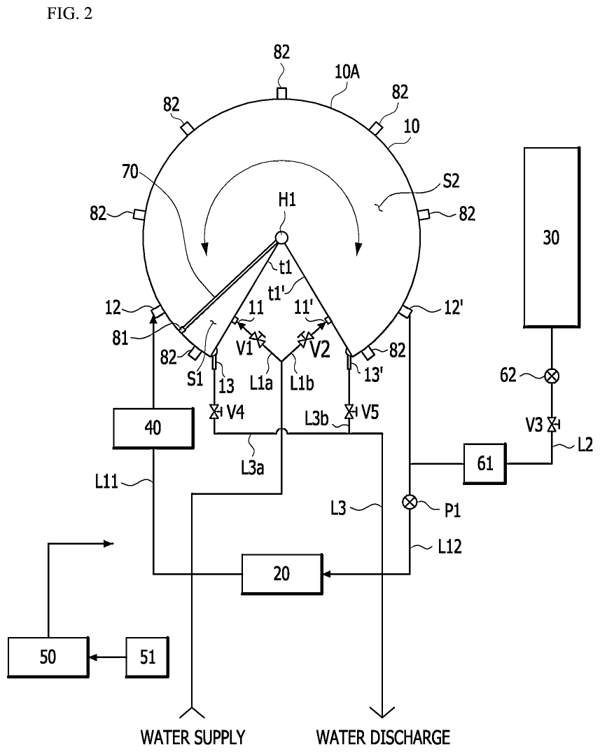

FIG. 2 illustrates an electrolyzed water generation device according to a second embodiment of the present invention in which a moving body 70, which is a separator film structure, is formed inside a first reservoir 10A which is a cylindrical tank structure, and the first reservoir 10A is divided into a first storage area S1 and a second storage area S2 which expand or contract. The moving body 70 may prevent supplied water from being mixed with completely generated electrolyzed water and may, when the water is supplied at a certain pressure to the first storage area S1, move due to the pressure. Simultaneously, the moving body 70 may open the fifth valve V5 formed in the fourth branch line L3b to discharge the generated electrolyzed water from the second storage area S2 through the water discharge line L3.

The moving body 70 may be a blade type separator film structure configured to rotate about a central axis H1 according to the pressure of the water selectively added through any one of the plurality of inlets 11 and 11′ formed in the first reservoir 10A. According to the rotation of the moving body 70, the water or the electrolyzed water added to the first storage area S1 or the second storage area S2 of the first reservoir 10A may be repeatedly circulated.

A magnetic body 81 may be formed at an end of the moving body 70, and at least one or more magnetic sensors 82 may be disposed in the first reservoir 10A and allow a movement position of the moving body 70 to be identified through the magnetic body 81.

When the magnetic body 81 rotates in conjunction with the rotation of the moving body 70, the magnetic sensor 82 may identify the position of the moving body 70 according to the rotation of the moving body 70 and then output the position to the controller 50. Meanwhile, in some cases, the amount of discharged water may be set, and the overall used amount may be measured according to the position detected by the magnetic sensor 82.

Therefore, when the first storage area S1 completely contracts based on the moving body 70 due to the moving body 70 being disposed at one end (the left side based on the drawings) inside the first reservoir 10A, the second storage area S2 expands. Accordingly, the controller 50 may control the second valve V2 formed in the second branch line L1b branched from the first supply line L1 to be closed and control the first valve V1 formed in the first branch line Lia branched from the first supply line L1 to be opened.

Then, the first storage area S1 of the first reservoir 10A expands due to the pressure of the water supplied from the first supply line L1, and due to the pressure of the water in this case, the completely generated electrolyzed water in the expanded second storage area S2 of the first reservoir 10A is discharged to the outside of the device through the water discharge line L3 by opening the fifth valve V5 of the fourth branch line L3b.

Through the above process, the water is pushed into the first storage area S1 by the pressure itself and causes the first storage area S1 to expand, and simultaneously, allows the generated electrolyzed water in the second storage area S2 to be completely discharged.

The controller 50 turns on the first pump 40 formed in the first circulation line L11, turns on the second pump 61 formed in the second supply line L2, and controls the third valve V3 to be opened.

Then, the water may circulate to the second circulation line L12, an electrolyte may be added to the water, and accordingly, salt water may be added to the electrolytic cell 20 connected to the second circulation line L12.

That is, the water stored in the first storage area S1 of the first reservoir 10A may be converted into water mixed with an electrolyte by circulating through the circulation port 12′ and the second circulation line L12 connected thereto, and the water mixed with the electrolyte may be added to the electrolytic cell 20. Accordingly, the electrolytic cell 20 may cause the water containing the electrolyte to undergo an electrolytic reaction to generate electrolyzed water.

The electrolyzed water generated in the electrolytic cell 20 may be circulated and pumped due to the first pump 40 formed in the first circulation line L11 being turned on and may cause the first storage area S1 of the first reservoir 10A to expand. That is, the water containing the electrolyte that is present in the storage space maximally expanded due to the moving body 70 rotating to move past the position of the circulation port 12′ of the second circulation line L12 may undergo an electrolytic reaction due to the electrolytic cell 20 such that electrolyzed water is generated, and the generated electrolyzed water may circulate in the expanded first storage area S1 due to the first pump 40 formed in the first circulation line L11.

When salt water, in which the water and the electrolyte are mixed, circulates in the electrolytic cell 20 through the second circulation line L12, the electrolyzed water generated due to the electrolytic reaction may circulate in the first reservoir 10A through the first circulation line L11. Through the repeated circulation, electrolyzed water having a set low concentration or high concentration may be generated and stored in the first storage area S1 of the first reservoir 10A.

That is, when the first valve V1 or the second valve V2 formed in the first branch line L1a or the second branch line L1b is selectively opened according to a control signal of the controller 50, the moving body 70 in the first reservoir 10A causes the first storage area S1 and the second storage area S2 to expand and contract alternately, and due to such an operation, the first storage area S1 and the second storage area S2 are repeatedly filled with water and discharge generated electrolyzed water. In other words, electrolyzed water having a set low concentration or high concentration that is stored in the first storage area S1 or the second storage area S2 of the first reservoir 10A may be used after being discharged to the outside when the fifth valve V5 or the fourth valve V4 formed in the fourth branch line L3b or the third branch line L3a of the water discharge line L3 is selectively controlled to be opened by the controller 50.

Meanwhile, for the electrolyzed water stored in the second storage area S2 of the first reservoir 10A to be completely discharged, the controller 50 may control only the first valve V1 formed in the first branch line Lia of the first supply line L1 to be opened to re-add the water to the contracted first storage area S1 of the first reservoir 10A.

Then, the moving body 70 disposed at the one end inside the first reservoir 10A may rotate due to the water added to the first storage area S1 through the first branch line L1a and may be disposed at the other end (the right side based on the drawings) inside the first reservoir 10A, and thus a storage space of the second storage area S2 may contract. Through such a process, electrolyzed water having a desired concentration may be generated and discharged.

Since the moving body 70 in the first reservoir 10A sufficiently moves past the circulation port 12′ or 12, the water added through the first branch line L1a may allow electrolyzed water generated in the electrolytic cell 20 to easily circulate through the first circulation line L11, the second circulation line L12, and the circulation port 12 or 12′ due to the operation of the first pump 40, and in this way, electrolyzed water having a desired concentration may be generated perfectly. In other words, the water may circulate to the second circulation line L12 connected to the electrolytic cell 20, and the controller 50 turns on the first pump 40 formed in the first circulation line L11, controls the third valve V3 formed in the second supply line L2 to be opened, and turns on the second pump 61.

Then, as the electrolyte pumped through the second supply line L2 is added to the water circulating in the second circulation line L12, the electrolyte (salt water or other electrolytes) may be added to the electrolytic cell 20 connected to the second circulation line L12.

That is, when the water stored in the first storage area S1 or the second storage area S2, which expands due to rotation of the moving body 70, is circulated through the circulation port 12′ or 12 and the second circulation line L12 or the first circulation line L11 connected thereto, in order to allow the water to circulate through the electrolytic cell 20 and the electrolyte to be added to the water and mixed therewith, the controller 50 turns on the second pump 61. Through such a process, the pumped electrolyte may be mixed with the water, and salt water or other electrolytes may be supplied to the electrolytic cell 20. Accordingly, the electrolytic cell 20 may cause the salt water to undergo an electrolytic reaction to generate electrolyzed water, and electrolyzed water having a set concentration may be generated in the first reservoir 10A.

The electrolyzed water generated in the electrolytic cell 20 may be added to the expanded first storage area S1 or second storage area S2 of the first reservoir 10A and mixed with the water according to a pumping pressure caused by the first pump 40 formed in the first circulation line L11 being turned on, and then an electrolyte may be added when the electrolyzed water is circulated through the second circulation line L12 or the first circulation line L11 again. A circulation process in which the electrolyzed water is re-added to the electrolytic cell 20 is repeated, and in this way, electrolyzed water having a set low concentration or high concentration may be stored in the first storage area S1 or the second storage area S2 of the first reservoir 10A.

More specifically, the electrolyzed water having a set low concentration or high concentration that is stored in the first storage area S1 of the first reservoir 10A may be used after being discharged to the outside when the second valve V2 formed in the second branch line L1b of the first supply line L1 is controlled to be opened, and the fourth valve V4 formed in the third branch line L3a of the water discharge line L3 is controlled to be opened.

As described above, in the second embodiment of the present invention, by rotating the moving body 70 and expanding the first storage area S1 or the second storage area S2 of the first reservoir 10A, the water may be stored therein. In addition, by circulating the water and adding an electrolyte to the circulating water, electrolyzed water may be generated through an electrolytic reaction. Here, re-circulation of the electrolyzed water to the electrolytic cell 20 through the first storage area S1 or the second storage area S2 is repeated. Then, electrolyzed water having a set low concentration or high concentration may be stored in the first storage area S1 or the second storage area S2, and electrolyzed water having a necessary concentration may be generated.

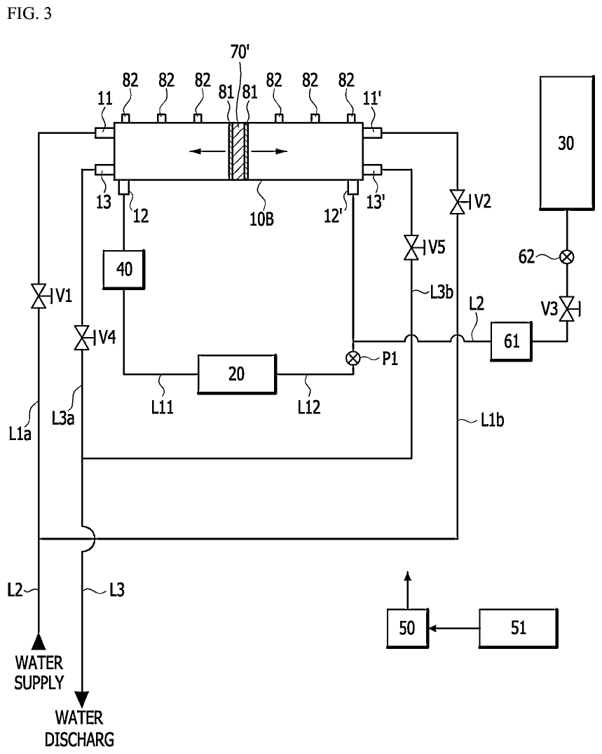

Meanwhile, FIG. 3 illustrates a third embodiment of the present invention in which a first reservoir 10B is configured as a cylinder-type or pipe-type tank structure in which the inlets 11 and 11′ and the water outlets 13 and 13′ are each disposed in different surfaces, and a moving body 70′, which is a piston type separator film structure configured to linearly move in a first direction or a second direction opposite to the first direction according to a pressure at which water is added, is formed inside the first reservoir 10B.

Here, the magnetic body 81 is formed at both ends of the moving body 70′, at least one or more magnetic sensors 82 are disposed in the first reservoir 10B which is the cylinder-type or pipe-type tank structure, and the magnetic sensor 82 may check linear movement positions of the magnetic body 81 and the moving body 70′ and output the linear movement positions to the controller 50.

Hereinafter, components overlapping with those in FIGS. 1 and 2, which illustrate the first and second embodiments of the present invention, will be denoted by the same reference numerals, and overlapping description thereof will be omitted.

That is, in the third embodiment of the present invention, all components may be identically configured as in the second embodiment of the present invention except that the first reservoir 10B is configured to be manufactured in a different shape from the first reservoir 10A, and while the moving body 70 configured to rotate is configured inside the first reservoir 10A, the moving body 70′ configured to linearly move is configured inside the first reservoir 10B.

The technical spirit of the electrolyzed water generation device of the present invention has been described above with reference to the accompanying drawings, but the embodiments described herein are only some examples of the embodiments of the present invention and are not intended to limit the present invention.

Therefore, the present invention is not limited to the specific embodiments described above, those of ordinary skill in the art to which the invention pertains may make various modifications without departing from the gist of the present invention claimed in the claims, and such modifications also fall within the scope of the claims.

### INDUSTRIAL APPLICABILITY

By an electrolyzed water generation device that automatically generates set electrolyzed water, electrolyzed water having a target concentration ranging from a low concentration to a high concentration can be generated, various types of electrolyzed water that fit different purposes can be generated through compact design, and efficiency of electrolyzed water generation can be improved using low power. Accordingly, it is possible to generate electrolyzed water used for various purposes at home or in business.

1. An electrolyzed water generation device comprising:
a first reservoir in which water supplied through a first supply line and electrolyzed water are stored for circulation;
an electrolytic cell connected to the first reservoir and first and second circulation lines and configured to cause salt water circulated through the second circulation line to undergo an electrolytic reaction to generate electrolyzed water and circulate the generated electrolyzed water to the first reservoir through the first circulation line;
a second reservoir connected to the second circulation line through a second supply line having a second pump formed therein and configured to store an electrolyte and add the electrolyte to the water circulated through the second circulation line so that salt water is added to the electrolytic cell;
a first pump formed in the first circulation line and operated to circulate the electrolyzed water generated in the electrolytic cell to the first reservoir; and
a controller configured to control added amounts of the water and the electrolyte and control on or off of the first pump and the second pump to circulate the electrolyzed water.

2. The electrolyzed water generation device of claim 1, wherein:
the first supply line is a water supply faucet line and branched into a first branch line and a second branch line; and
a first valve and a second valve simultaneously or selectively controlled to be opened or closed by the controller are formed in the first branch line and the second branch line, respectively.

3. The electrolyzed water generation device of claim 2, wherein the first reservoir has:
a plurality of inlets each connected to one of the first branch line and the second branch line;
a plurality of circulation ports each connected to one of the first circulation line and the second circulation line; and
a plurality of water outlets configured to discharge the electrolyzed water circulated to the first reservoir and stored therein to the outside.

4. The electrolyzed water generation device of claim 1, wherein a third valve controlled to be opened or closed by the controller and a check valve configured to prevent a backflow of the electrolyte to the second reservoir are formed in the second supply line.

5. The electrolyzed water generation device of claim 3, wherein:
a third branch line and a fourth branch line branched from a water discharge line are each connected to one of the plurality of water outlets; and
a fourth valve and a fifth valve simultaneously or selectively controlled to be opened or closed by the controller are formed in the third branch line and the fourth branch line, respectively.

6. The electrolyzed water generation device of claim 1, wherein a pressure sensor configured to check a pressure of the water introduced into the electrolytic cell, check a water pressure acting on the first reservoir and the electrolytic cell to prevent damage to the first reservoir and the electrolytic cell due to the water pressure, and send the checked water pressure to the controller is formed in the second circulation line.

7. The electrolyzed water generation device of claim 1, wherein the controller controls a duration of the electrolytic reaction of the salt water in the electrolytic cell by controlling the added amounts of the water and the electrolyte and the on or off of the first pump and the second pump according to a predetermined amount of time using a timer.

8. The electrolyzed water generation device of claim 3, wherein the first reservoir is a cylindrical tank structure having cut surfaces that face each other and each have one of the inlets and one of the water outlets disposed therein.

9. The electrolyzed water generation device of claim 3, wherein the first reservoir is a cylinder-type or pipe-type tank structure in which the inlets and the water outlets are each disposed in different surfaces.

10. The electrolyzed water generation device of claim 8, wherein a moving body configured to move according to a pressure of water selectively added through any one of the plurality of inlets and divide the first reservoir into a first storage area and a second storage area is formed in the first reservoir.

11. The electrolyzed water generation device of claim 10, wherein:
a magnetic body is formed at an end of the moving body; and
at least one or more magnetic sensors configured to measure a movement position of the moving body through the magnetic body are formed in the first reservoir.

12. The electrolyzed water generation device of claim 10, wherein the moving body is a blade type separator film structure configured to rotate about a central axis inside the first reservoir which is the cylindrical tank structure.

13. The electrolyzed water generation device of claim 10, wherein the moving body is a piston type separator film structure configured to linearly move in a first direction or a second direction opposite to the first direction inside the first reservoir which is the cylinder-type or pipe-type tank structure.

14. The electrolyzed water generation device of claim 9, wherein a moving body configured to move according to a pressure of water selectively added through any one of the plurality of inlets and divide the first reservoir into a first storage area and a second storage area is formed in the first reservoir.

15. The electrolyzed water generation device of claim 14, wherein:
a magnetic body is formed at an end of the moving body; and
at least one or more magnetic sensors configured to measure a movement position of the moving body through the magnetic body are formed in the first reservoir.

16. The electrolyzed water generation device of claim 14, wherein the moving body is a blade type separator film structure configured to rotate about a central axis inside the first reservoir which is the cylindrical tank structure.

17. The electrolyzed water generation device of claim 14, wherein the moving body is a piston type separator film structure configured to linearly move in a first direction or a second direction opposite to the first direction inside the first reservoir which is the cylinder-type or pipe-type tank structure.
